(19) United States
(12) Patent Application Publication
(10) Pub. No.: US 2019/0226721 A1
(43) Pub. Date: Jul. 25, 2019

(54) AUTOMATIC HYDRAULIC MOTION SYSTEM OF ELEMENTS OF A COMPACT SOLAR COLLECTOR

(71) Applicant: CORDIVARI S.R.L., Morro d'Oro TE (IT)

(72) Inventors: Daniele Dl GIANNATALE, Morro d'Oro TE (IT); Ercole CORDIVARI, Morro d'Oro TE (IT)

(21) Appl. No.: 16/316,620

(22) PCT Filed: Aug. 4, 2017
(86) PCT No.: PCT/IT2017/000166

§ 371 Date: Jan. 9, 2019

(30) Foreign Application Priority Data
Aug. 10, 2016 (IT) 102016000084083

(51) Int. Cl. F24S 50/00; F24S 40/52; F24S 30/45

(52) U.S. Cl. CPC F24S 50/00; F24S 10/45; F24S 30/45; F24S 40/52

(57) ABSTRACT

Automatic motion system by dilatation of a fluid, said system acting on elements of a compact solar collector with integrated storage tank, said solar collector having least a face exposed to the solar radiation and at least another face not facing the solar radiation, said solar collector comprising a plurality of primary tubes (1), for containing at least one primary heat carrier element adapted to the storage of thermal energy, and an external sensor element arranged movable with respect to each primary conduit (1), adapted to overlap, at least partially, during its motion, in each primary conduit (1).

The present invention relates to an automatic motion system of elements of a compact solar collector with integrated storage tank.

More specifically, the present invention relates to a motion system for actuating kinematics in solar systems automatically operated by increasing of the temperature of a fluid within a set technical volume.

As it is known, a fluid subjected to a temperature increase, naturally increases its volume; in case it is not possible providing the fluid during the dilation stage the volume required for its expansion, it will tend to increase its pressure as long as the temperature increase will not cease. The pressure generated within the aforementioned technical volume can be exploited to operate devices converting the energy contained in the fluid, in this case in the form of pressure, into other forms.

This principle is used in some devices such as thermostatic devices, used for automatic regulating heaters, and thermostatic lever valves, used to regulate air dragging in biomass heaters.

The first are essentially of three types: wax, liquid and gas heaters. In the wax ones, the sensor is made up of a hard casing filled in with wax. With the temperature increase, wax dilates and pushes the shutter into a closure position by winning the resistance of a preloaded spring. They are sensors characterized by long response times (many tens of minutes) to reach the balancing position.

In liquid thermostatic devices, the sensor consists of a rigid casing filled in with a liquid, usually alcohol, acetone or organic liquid mixtures similar to those used in thermometers. As the temperature increases, the liquid expands and pushes the shutter in a closure position by winning the resistance of a preloaded spring. They are currently among the most used sensors since they can ensure a good response time.

In the last type of thermostatic device, the sensor is made up of a rigid casing filled in with a gas. As the temperature increases, the gas dilates and pushes the shutter into a closure position, winning the resistance of a preloaded spring. Gas is compressible and this can be a problem in presence of too high differential pressures that can lead to unwanted opening of the shutter.

Valves used in biomass stoves use the same principle as thermostatic devices: when the temperature of the water is varied in the generator interspace, the dragging adjuster modifies the opening of the combustion air intake door by dilatation or contraction of the thermostatic sensor connected to the lever mechanism formed by the control shaft and chain.

It is also known that compact solar collectors generally have a large dimension and a reduced thickness, and contain inside them the storage tank of the fluid to be heated, preferably sanitary water, and are characterized by excellent energy exchange efficiency and low thermal inertia efficiency. In case of compact indirect irradiation solar collectors, they also include a storage tank for a direct solar irradiated primary fluid and can provide heat to the fluid to be heated or secondary fluid.

Compact solar collectors also have the advantage of being simple to install, as it is sufficient to connect the inlet and outlet tubes to the user.

At present, such compact solar collectors have the disadvantage of not maintaining the same thermal efficiency even during night time. In fact, since the accumulation of fluid to be heated directly exposed to sunlight, it tends to reduce during night time. Thus, the day-catching efficacy prerogative generates the same limit as the capability to maintain the accumulated energy overnight. At present no solutions exist able to insulate such accumulation without inhibiting the necessary capturing capacity.

Alternatively, known techniques include solar collectors comprising a sensor capable of capturing solar energy, and a separate storage tank and fluid connection with the sensor device for storing the fluid to be heated. The accumulation is therefore appropriately insulated from the outside and allows to store accumulated heat during daytime hours and to limit dispersions to the outside. However, in such solar collectors, the accumulation has far larger dimensions than its net useful capacity to contain the heated liquid, which therefore has rather large dimensions.

Further, compact solar collectors including vacuum tubes are known as sensor elements, within which the tubes in which the fluid to be heated flow, are known. Vacuum tubes allow to reduce night thermal dispersions through the upper cover. As it is well known, the best thermal insulator is vacuum because in the presence of the same, no convective thermal exchange mechanisms due to the free circulation of vortices that are generated within all fluids due to the temperature gradients. In these collectors, the sensor system is positioned within special concentric tubes to which the task of thermal isolation of the capture is due. This insulating capacity is achieved by creating a chamber in which the vacuum is realized. Thanks to the insulating characteristic of vacuum tube, it is therefore possible to increase the temperature of the fluid to be heated flowing through the tubes. However, the temperature of such fluid can sometimes reach very high levels. If overheating becomes uncontrolled, damage to the implant or its components may occur.

A direct problem due to excessive overheating of the tubes is connected to the excessive limestone precipitation.

In fact, excessive heating, for a high water hardness value (containing high amounts of limestone), causes an excessive precipitation of limestone that can lead to the incrustation of tubes or ducts.

At present, there are also systems of solar shields electrically operated and controlled by a temperature sensor placed inside the solar collector or of the system. Said systems are essentially comprised of an electric motor and a shielding system. In the flat collectors field, shielding is generally made up of a shutter, while in the vacuum tube collectors it can be either a shutter or lamellae coaxial with respect to the sensor tubes. The weakness of these types of shields lies in the fact that, in the absence of electric current, they are not able to guarantee the protection of the solar system against over temperature or, when placed in a closed condition in case of power failure, the interruption of the system itself. Another necessary condition, perhaps obvious, is the need to receive power through suitable systems in the installation locations. Another generic limitation of such electrical shielding systems is that they are usually not modulating because they interact with the logic on/off sensor system on the temperature readings established on a timely basis.

The object of the present invention is to replace the normal electric drives with systems capable of ensuring the protection of solar collectors in any condition, even in the absence of electric current, with the intrinsic ability to self-regulate the solar system sensor needing.

It is therefore specific object of the present invention an automatic motion system by dilatation of a fluid. Said system acting on elements of a compact solar collector with integrated storage tank. Said solar collector having least a face exposed to the solar radiation and at least another face not facing the solar radiation, said solar collector comprising a plurality of primary tubes, for containing at least one primary heat carrier element adapted to the storage of thermal energy, and an external sensor element arranged movable with respect to each primary conduit, adapted to overlap, at least partially, during its motion, in each primary conduit.

In a preferred embodiment of the system according to the invention, it is provided a return spring, acting on said hydraulic cylinder.

Preferably, according to the invention, each sensor element is able to rotate on itself, preferably of 180°, with respect to the respective primary duct.

Always according to the invention, said drive and transmission means preferably comprise at least a hydraulic cylinder and of motion transmission mechanisms such as one or more racks.

In said embodiment, transmission of motion is realised by gears having different dimensions.

Always according to a preferred embodiment of the invention the rack acts simultaneously on all the gears.

Preferably, according to the invention, said sensor element is comprised of a vacuum tube, disposed coaxially with respect to each primary tube.

Furthermore, according to the invention, said shielding element is comprised of the same sensor tube, in particular by a portion of the same suitably made opaque to solar radiation.

Always according to the invention, said drive and transmission means acting on said external sensor elements are configured so as to move said external sensor elements between a sensing position and a shielding position, and vice versa, as a function of the pressure in said primary tubes and/or as a function of said at least one primary heat carrier element temperature.

Still according to the invention, said drive and transmission means are configured so that when the pressure increases in said primary tubes above a first value, said drive and actuating means act on said external sensor elements to pass towards said shielding position, and when said pressure decreases in said primary tubes, said actuating means bring back said external sensor elements towards said sensing position.

As it is known, the work done by a fluid when, in case of a temperature increase, it is allowed to expand, can be exploited to operate kinematics in solar collectors. In particular, these kinematics operate shields to prevent the panel from stagnating. Even more particularly, these kinematics move vacuum tubes of compact or standard panels, lamellae coaxial with respect to compact or standard panel vacuum tubes, shutters in flat panels.

By the aforementioned system, it is also possible to move the solar collector, either flat or tubular, so as to favorably align the capturing surface with respect to the sun's rays and increase the effective efficiency of the system.

The motion of the entire collector can also be exploited to prevent the system from continuing to absorb solar radiation in case of a rise temperature beyond a threshold value.

By dimensioning the hydraulic cylinder on the basis on the force required to operate the kinematics and the volume required for the expansion of the technical accumulation, it is possible to obtain mechanisms with multiple characteristics in terms of force and driving.

The choice of the stroke, characterizing the hydraulic cylinder, is carried out in such a way to ensure the expansion volume required by the primary fluid contained in the accumulation in the operating temperature range. This also limits the pressure increase which, given the use of incompressible fluid, would tend to be high: the system also functions as an expansion vessel.

Since there is a single pressure in this automatic hydraulic system, the return of the hydraulic cylinder will preferably be carried out by means of a suitably dimensioned return spring. The use of the spring allows you to accumulate a sufficient amount of energy in the form of elastic energy that will be returned at the return stroke or when the cylinder operation pressure tends to decrease.

The invention will now be described for illustration but not limitative purposes, with particular reference to the figures of the accompanying drawings, wherein:

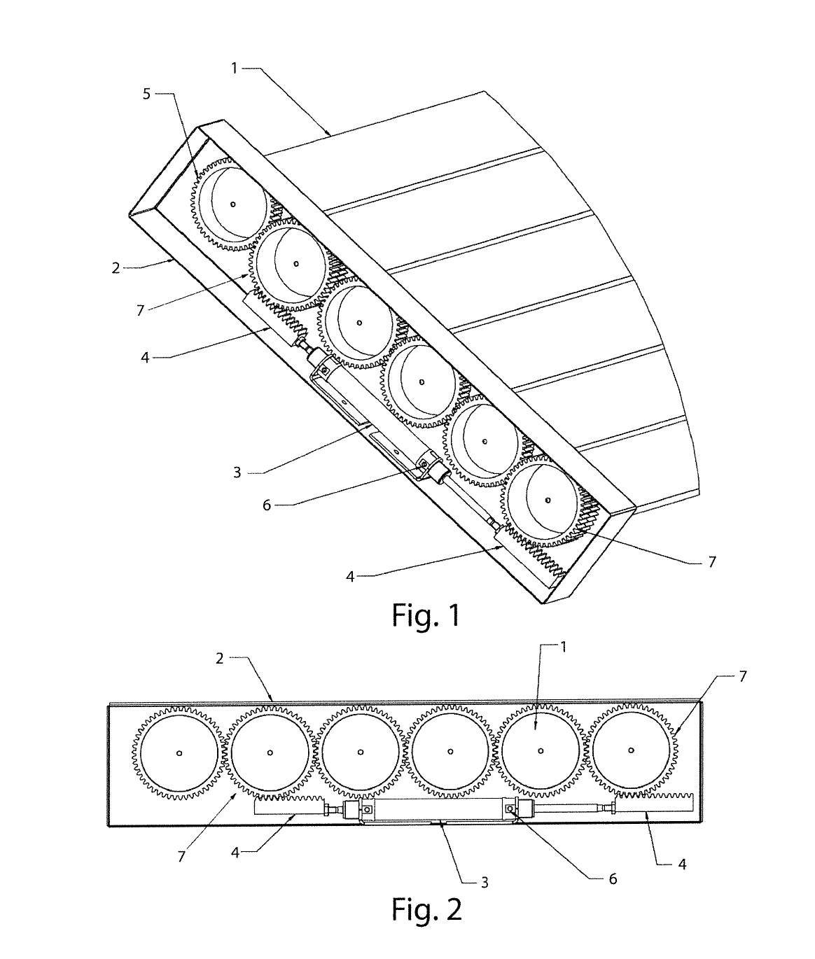

FIG. 1 is a perspective view of a first embodiment of the motion system according to the invention;

FIG. 2 is a side view of the system of FIG. 1;

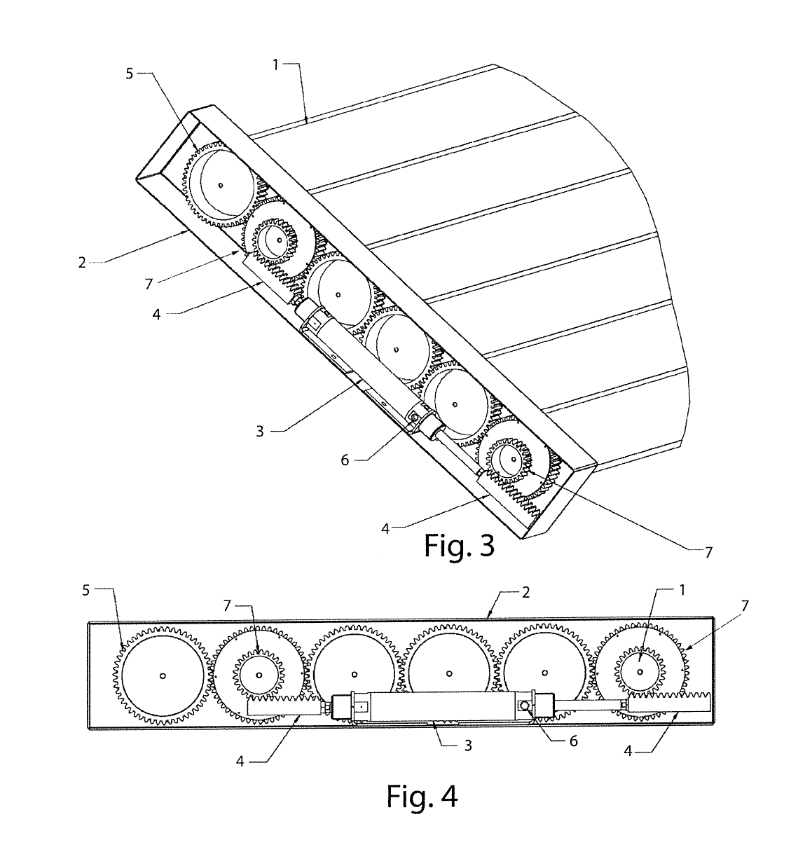

FIG. 3 is a perspective view of a second embodiment of the motion system according to the invention;

FIG. 4 is a side view of the system of FIG. 3;

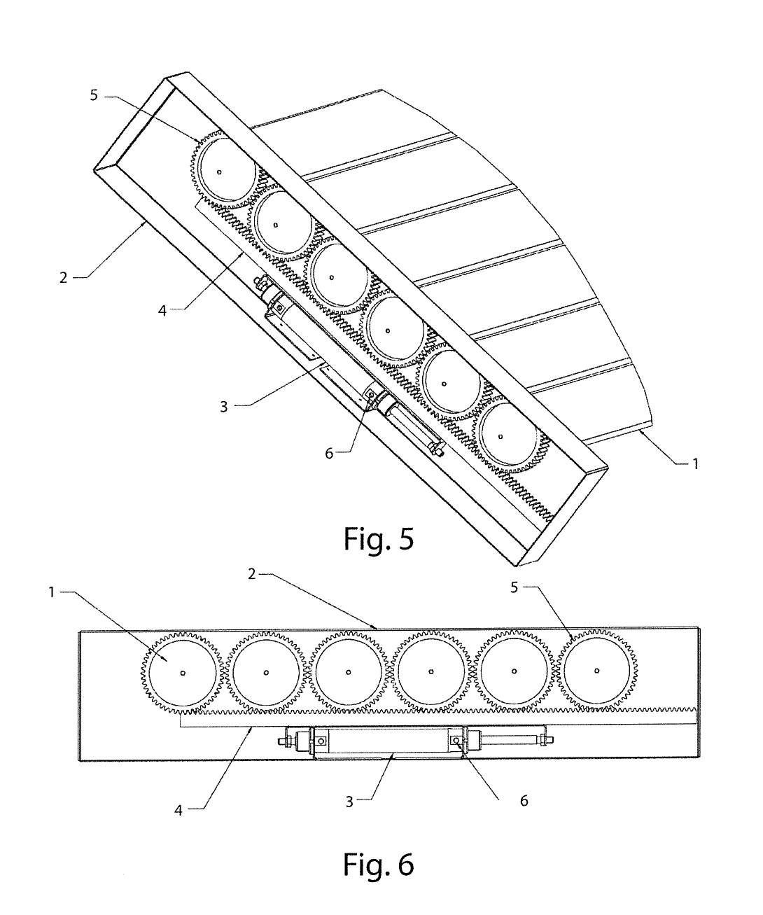

FIG. 5 is a perspective view of a third embodiment of the motion system according to the invention;

FIG. 6 is a side view of the system of FIG. 5;

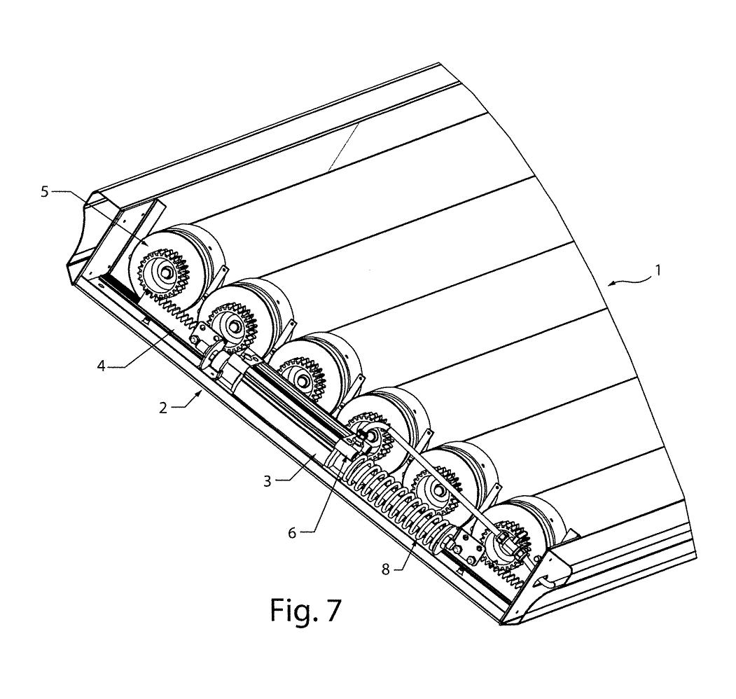

FIG. 7 is a perspective view of a fourth embodiment of the motion system according to the invention; and

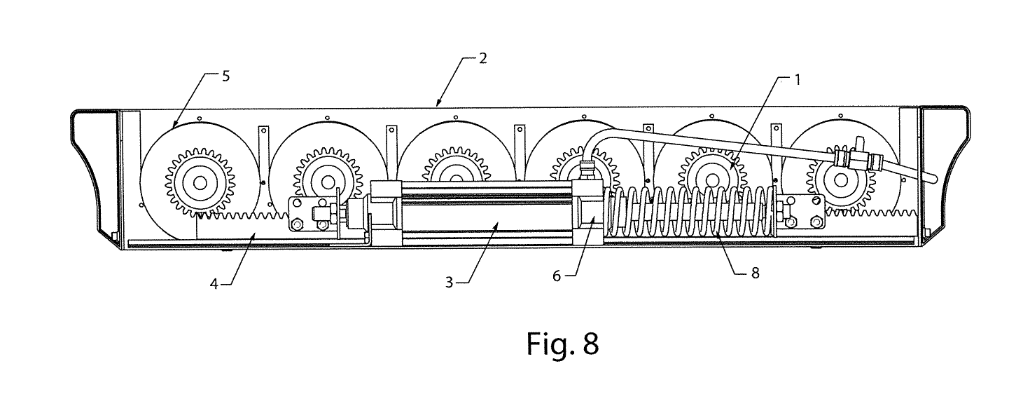

FIG. 8 is a side view of the system of FIG. 7.

In a solar collector, the shielding system has the function of blocking solar radiation and not allowing its penetration inside the collector to the tube portion with the selective coating and thus contributing to the heating of the primary fluid.

In FIGS. 1 to 8, the system according to the invention is shown applied to a solar collector, in which the shielding system is formed by the same glass tubes also acting as sensors.

However, as said, the same system can also be provided on solar collectors provided with a different protection system, such as rotating laminae, which cover single a tube 1 for a 180° arc.

In the embodiment shown, for example, films are applied on each sensor tube, said films being opaque to the solar radiation initially directed on the opposite side to the sun's rays. When the system rises temperature, the pressure inside the primary fluid begins increasing; now, the automatic shielding system starts having a role. By means of a system consisting of rack and toothed wheels, the linear motion of the piston is converted into a rotary motion, allowing the sensor tubes to expose the shielding part. At this point the solar collector begins to self-regulate: at a pressure increase it will correspond the advancement of the piston and its exposure by the sensors of the opaque surface; when the pressure decreases due to a decrease in the solar collector temperature, for example due to a user's energy withdrawal or to a decrease in solar irradiation, it will correspond to a retraction of the piston that will bring the system into sensor mode, i.e. with the shielding part in the starting position.

Referring particularly to FIGS. 1 and 2, it is shown a first embodiment of the system according to the invention, in which the glass sensor tube 1, the structure 2, the hydraulic cylinder 3, the rack 4, the driven toothed wheels 5, the hydraulic cylinder pressure intake 6, and the drive gear wheels 7.

In this specific embodiment, the hydraulic cylinder 3 acts on two driving wheels 7, which, with the adjacent gears, transfer the rotary motion to the whole pipe system 1. The driving wheels 7 have a greater gear width so as to allow the rack 4 to engage without interfering with the teeth of the driven wheels 5.

In the embodiment shown in FIGS. 3 and 4, respectively, a perspective view and a side view of a second embodiment, in which the same numerical references are used to indicate parts corresponding to those of FIGS. 1 and 2, the driving wheels 7 have a lower diameter than that of the first embodiment. In this way, with the same stroke of the hydraulic cylinder 3, it is possible to make the tube system 1 realizing a larger rotation.

FIGS. 5 and 6 respectively show a perspective view and a side view of a third embodiment, in which the same numeral references are used to indicate parts corresponding to those of the preceding figures.

In this embodiment, the rack 4 acts on all the toothed wheels 5 simultaneously. The latter do not engage each other, allowing the system according to the invention to be operated using a lesser force for its motion, since the friction component introduced by mutual interaction between the wheels has been eliminated.

FIGS. 7 and 8 are respectively a perspective view and a side view of a fourth embodiment of the system according to the invention, in which the same numeral references are used to indicate parts corresponding to those of the preceding figures.

In this embodiment, besides to eliminating the friction component due to mutual interaction between the teeth of the wheels 5 by using smaller diameter driving wheels, it is possible to obtain the desired rotation of the tube system 1 using a cylinder 3 having a lower stroke. Therefore, a shorter length of the rack 4 and, consequently, a greater compactness of the whole system according to the invention may be provided.

On the piston rod there is provided a return spring 8. This embodiment, for its adjustment, requires the optimization of various variable, such as: features of the return spring 8, fluid volume which, by expanding, activates the cylinder 3 hydraulic cylinder 3 characteristics, nature and dimensions of the transmission of the motion means 4, 5, 6, 7.

In particular, the characteristics of the spring 8 in terms of length, useful stroke, and elastic constant must allow for the counter-force required to make the movement reversible. The spring 8 will then be dimensioned to ensure, with a preload choice, said force.

The characteristics of the hydraulic cylinder 3 allow to deliver the required force for the movement and at the same time ensure the fluid expansion volume so as not to reach too high pressures.

The geometry of the motion transmitting means 4, 5, 6, 7 finally has to allow the optimization of shielding degree. Particularly, the specific choice of this geometry allows for the rotation of the required shield with the minimum stroke of the piston by reducing the cost, weight and size of the hydraulic cylinder.

The balance created between these different features allows for a dynamic shielding of the solar collector.

Particularly, when the temperature within the primary fluid grows, the system begins to move and partially block incoming solar radiation as long as the power provided by the sun is exactly the same as that dissipated from the system outward in terms of thermal dispersions.

In this ways maximum efficiency of the system is always ensured and at the same time maintains the integrity of the system as the high temperatures are limited.

Further, the use of adhesive shielding elements helps to avoid the problems caused by the wind. Positioning shields independently rotating with respect to the glass tubes may lead to instability or resonance phenomena that would put the tube's integrity at risk.

In the above, the preferred embodiments have been described and variants of the present invention have been suggested, but it is to be understood that those skilled in the art will be able to make modifications and changes without departing from the scope as defined by the enclosed claims.

1. Automatic motion system by dilatation of a fluid, said system acting on elements of a compact solar collector with integrated storage tank, said solar collector having least a face exposed to the solar radiation and at least another face not facing the solar radiation, said solar collector comprising a plurality of primary tubes (1), for containing at least one primary heat carrier element adapted to the storage of thermal energy, and an external sensor element arranged movable with respect to each primary conduit (1), adapted to overlap, at least partially, during its motion, in each primary conduit (1), wherein each sensor element is able to rotate on itself, preferably of 180°, with respect to the respective primary duct (1) and in that drive and transmission means (3, 4, 5, 6, 7) are provided, preferably comprised of at least a hydraulic cylinder (3) and of motion transmission mechanisms such as one or more racks (4).

2. System according to claim 1, wherein said system is provided a return spring (8), acting on said hydraulic cylinder (3).

3. System according to claim 1, wherein transmission of motion is realised by gears (5, 7) having different dimensions.

4. System according to claim 2, wherein the rack (4) acts simultaneously on all the gears (5, 7).

5. System according to claim 1, wherein said sensor element is comprised of a vacuum tube, disposed coaxially with respect to each primary tube (1).

6. System according to claim 1, wherein said shielding element is comprised of the same sensor tube, in particular by a portion of the same suitably made opaque to solar radiation.

7. System according to claim 1, wherein said drive and transmission means (3, 4, 5, 6, 7) acting on said external sensor elements are configured so as to move said external sensor elements between a sensing position and a shielding position, and vice versa, as a function of the pressure in said primary tubes (1) and/or as a function of said at least one primary heat carrier element temperature.

8. System according to claim 7, wherein said drive and transmission means (3, 4, 5, 6, 7) are configured so that when the pressure increases in said primary tubes (1) above a first value (P1), said drive and actuating means (3, 4, 5, 6, 7) act on said external sensor elements to pass towards said shielding position, and when said pressure decreases in said primary tubes (1), said actuating means (3, 4, 5, 6, 7) bring back said external sensor elements towards said sensing position.

9. System according to claim 2, wherein transmission of motion is realised by gears (5, 7) having different dimensions.

10. System according to claim 3, wherein the rack acts simultaneously on all the gears.

11. System according to claim 9, wherein the rack acts simultaneously on all the gears.

12. System according to claim 2, wherein said sensor element is comprised of a vacuum tube, disposed coaxially with respect to each primary tube.

13. System according to claim 3, wherein said sensor element is comprised of a vacuum tube, disposed coaxially with respect to each primary tube.

14. System according to claim 4, wherein said sensor element is comprised of a vacuum tube, disposed coaxially with respect to each primary tube.

15. System according to claim 2, wherein said drive and transmission means acting on said external sensor elements are configured so as to move said external sensor elements between a sensing position and a shielding position, and vice versa, as a function of the pressure in said primary tubes and/or as a function of said at least one primary heat carrier element temperature.

16. System according to claim 3, wherein said drive and transmission means acting on said external sensor elements are configured so as to move said external sensor elements between a sensing position and a shielding position, and vice versa, as a function of the pressure in said primary tubes and/or as a function of said at least one primary heat carrier element temperature.

17. System according to claim 9, wherein said drive and transmission means acting on said external sensor elements are configured so as to move said external sensor elements between a sensing position and a shielding position, and vice versa, as a function of the pressure in said primary tubes and/or as a function of said at least one primary heat carrier element temperature.

18. System according to claim 4, wherein said drive and transmission means acting on said external sensor elements are configured so as to move said external sensor elements between a sensing position and a shielding position, and vice versa, as a function of the pressure in said primary tubes and/or as a function of said at least one primary heat carrier element temperature.

19. System according to claim 10, wherein said drive and transmission means acting on said external sensor elements are configured so as to move said external sensor elements between a sensing position and a shielding position, and vice versa, as a function of the pressure in said primary tubes and/or as a function of said at least one primary heat carrier element temperature.

20. System according to claim 11, wherein said drive and transmission means acting on said external sensor elements are configured so as to move said external sensor elements between a sensing position and a shielding position, and vice versa, as a function of the pressure in said primary tubes and/or as a function of said at least one primary heat carrier element temperature.
